(19) United States
(12) Patent Application Publication
(10) Pub. No.: US 2007/0280304 A1
(43) Pub. Date: Dec. 6, 2007

(54) Hollow Core Fiber Laser

(76) Inventors: Jochen Deile, West Hartford, CT (US); Markus Schwandt, Garlingen (DE)

Correspondence Address: FISH & RICHARDSON PC, P.O. BOX 1022, MINNEAPOLIS, MN, 55440-1022, US

(21) Appl. No.: 11/422,185

(22) Filed: Jun. 5, 2006

(51) Int. Cl. H01S 3/30

(52) U.S. Cl. 372/6

(57) ABSTRACT

A laser includes a optical fiber having a cladding that defines a core, a laser active medium within the core of the optical fiber, a first reflector and a second reflector defining a cavity within at least a portion of the optical fiber; and an excitation system coupled to the laser active medium to stimulate laser action within the core of the optical fiber. The laser active medium can be a gas, a liquid, or a solid.

### TECHNICAL FIELD

The invention relates to lasers, and more particularly to hollow core fiber lasers.

### BACKGROUND

In general, the output power from a laser is proportional to the power input into the laser active medium of the laser. However, for high power lasers this relationship can break down because of difficulties in extracting heat from the laser active medium. For high power lasers, cooling of the laser active medium is a critical task, and the heat removal rate from the laser active medium limits the total output power and/or other important laser characteristics (for example, beam quality) in industrial laser systems.

In diffusion cooled gas lasers (for example, CO₂ lasers), laser light is generated within a gas discharge, and waste heat is generally transported to cooled walls of the laser discharge vessel by a diffusion process. Commercially available diffusion cooled lasers with cylindrical geometries are characterized by radial temperature gradients and can generate several hundred watts of continuous wave (“cw”) laser power. The output power of such lasers generally scales with the length of the gas discharge within the laser resonator, while the heat generated within the gas discharge is dissipated over the surface area of the discharge electrodes.

Another type of laser is a solid core fiber laser, in which an optical fiber includes a laser active dopant within a solid fiber core between integrally formed reflective end sections of the fiber. The laser active dopant is pumped (typically with pump light) to create laser activity within the solid core of the fiber, and the laser light generated within the optical fiber is guided along the length of the fiber.

### SUMMARY

In one general aspect, a hollow core fiber laser includes an optical fiber including a cladding that defines a hollow core, a laser active medium within the core of the optical fiber, a first reflector and a second reflector defining a cavity within at least a portion of the optical fiber, and an excitation system coupled to the laser active medium to stimulate laser action within the core of the optical fiber. In this way, a laser cavity is created by filling a hollow core optical fiber with a laser active medium and a placing reflectors at ends of the optical fiber. The laser active medium can be a gas, a liquid, or a solid such as a solid particulate. When the gain of light along the length of the laser active medium is greater than the loss, laser activity can result.

Implementations can include one or more of the following features. For example, the excitation system can include an electrical power source, and at least one electrode adapted for coupling electrical energy from the electrical power source through the cladding into the laser active medium. The electrode can include a coil wrapped around the optical fiber, wherein the coil is adapted for inductively coupling electromagnetic energy into the laser active medium. The electrode can include a pair of plates around the optical fiber, wherein the plates are adapted for capacitively coupling electromagnetic energy into the laser active medium. The electrical power source can include an oscillator adapted for producing an oscillating electromagnetic signal. The electromagnetic signal produced by the oscillator can have a frequency between about 1 kHz and about 100 GHz.

The reflectors can be mirrors. At least one of the reflectors can be a distributed Bragg reflector.

The laser active medium can be a gas, for example carbon dioxide. The laser active medium can be a fluid, for example a laser active dye.

The laser can include a cooling jacket surrounding at least a portion of the optical fiber, and a cooling fluid flowing through the cooling jacket.

The laser can include a means for creating a magnetic field in a direction approximately parallel to at least a portion of the optical fiber. The laser can include a permanent magnet arranged to create a magnetic field in a direction approximately parallel to at least a portion of the optical fiber. The laser can include an electromagnet arranged to create a magnetic field in a direction approximately parallel to at least a portion of the optical fiber.

The optical fiber can be arranged in a loop. The core of the fiber can have a diameter that is less than about 100 times greater than a wavelength of light emitted from the laser. The cladding of the fiber can include alternating layers, in a radial direction, of high and low index of refraction material. The cladding of the fiber can include at least 10 alternating layers of high and low index of refraction material. The optical fiber can be a photonic bandgap fiber. The cladding of the fiber can include a metallic layer.

In another general aspect, a method of generating laser radiation includes providing an optical fiber having a laser active medium within a core of the fiber, providing a first reflector and a second reflector between which at least a first portion of the optical fiber is located, the first and second reflectors and the first portion of the optical fiber defining a laser cavity, and coupling sufficient energy through the optical fiber to generate laser radiation within the laser cavity.

Implementations can include one or more of the following features. For example, coupling sufficient energy can include coupling sufficient electromagnetic energy through a cladding of the optical fiber. The method can include flowing the laser active medium through the core of the optical fiber.

The method can include flowing a cooling fluid around at least a second portion of the optical fiber, and coupling the energy through the cooling fluid to the laser active medium.

The method can include creating a magnetic field in a direction approximately parallel to at least a portion of the optical fiber.

In another general aspect, a method of making a laser includes preparing a hollow preform, drawing the hollow preform into a hollow fiber cladding that defines a core, filling the core with a laser active medium, coupling reflectors to the hollow fiber cladding to form a hollow core optical fiber, and coupling an excitation system to the laser active medium to enable laser action within the hollow core optical fiber.

Implementations can include one or more of the following features. For example, the core can be filled with the laser active medium by filling the core with a gaseous laser active medium. The core can be filled with the laser active medium by filling the core with a liquid laser active medium. The core can be filled with the laser active medium by filling the core with a solid laser active medium.

Coupling sufficient energy can include inductively coupling electromagnetic energy into the laser active medium of the optical fiber. Coupling sufficient energy can include capacitively coupling electromagnetic energy into the laser active medium of the optical fiber.

The hollow core fiber laser exhibits relatively high laser power and relatively high heat dissipation without requiring an optical folding of the laser resonator, without employing a complicated laser resonator design, and without the use of a laser diode pumping mechanism. The hollow core fiber laser has reduced non-linear effects that can sometimes arise from the use of solid fibers. Additionally, the hollow core fiber laser exhibits low transmission losses at a variety of wavelengths, and thus the hollow core optical fiber is not restricted to particular wavelengths.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a schematic side view of a hollow core fiber laser including a hollow core optical fiber pumped with a laser excitation system having an inductive coil.

FIG. 2 is a flow chart of a procedure for forming the hollow core fiber laser of FIG. 1.

FIG. 3 is a schematic side view of a hollow core fiber laser including a hollow core optical fiber pumped with a laser excitation system having a capacitive excitation.

FIG. 4 is a schematic cross-sectional view of a hollow core optical fiber having a multilayer cladding.

FIG. 5 is a schematic cross-sectional view of a hollow core optical fiber having a multilayer cladding.

FIG. 6 is a schematic cross-sectional view of a hollow core optical fiber having a uniform material cladding.

FIG. 7 is a schematic side view of a hollow core fiber laser including a water cooling system and an active medium recirculation system.

FIGS. 8A-8C are schematic views of hollow core fiber lasers including a coiled hollow core optical fiber pumped with various laser excitation systems.

FIGS. 9A-9C are schematic side views of a hollow core optical fiber with various resonator reflectors.

Like reference symbols in the various drawings indicate like elements.

### DETAILED DESCRIPTION

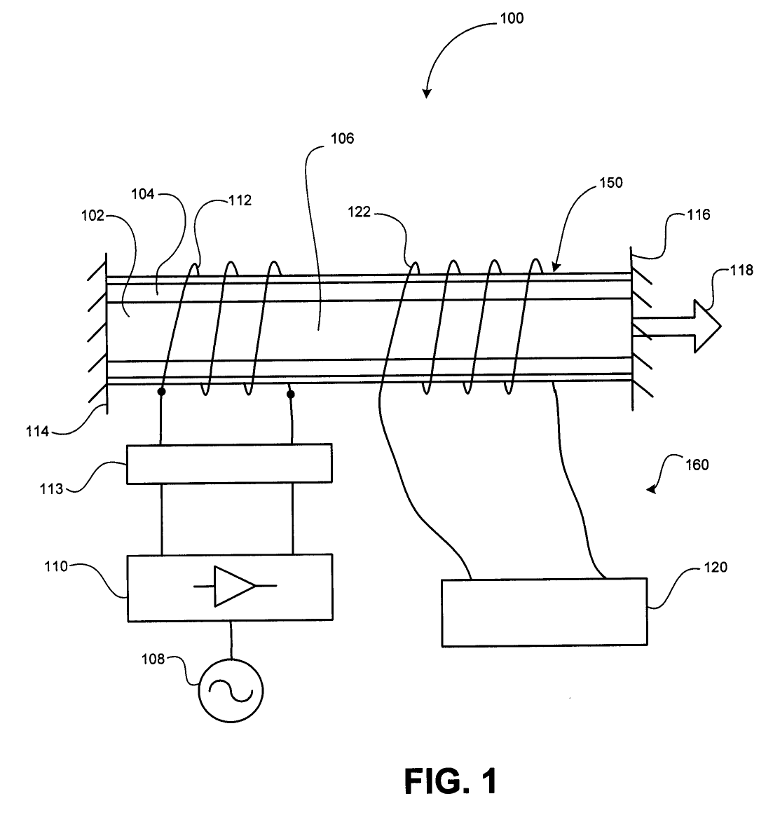

As shown in FIG. 1, a hollow core fiber laser 100 includes a hollow core optical fiber 150 that is pumped with a laser excitation system 160. The hollow core optical fiber 150 includes a cladding 104 that defines a hollow core 102, and a laser active medium 106 contained within the hollow core 102. As described in more detail below, the hollow core optical fiber 150 is designed and fabricated to transmit electromagnetic radiation of particular wavelengths through the fiber 150 with very low loss (for example, less than about 0.1 dB/m). The laser excitation system 160 couples energy into the laser active medium 106 to excite the laser active medium 106 and stimulate spontaneous emission of radiation within the laser active medium 106.

For example, the laser active medium 106 can be a fluid (for example, a liquid or a gas). For example, the laser active medium 106 can be a liquid such as a laser active dye that can be excited and then stimulated by the laser excitation system 160 to spontaneously emit radiation. In another example, the laser active medium 106 can be a gas that can be excited and stimulated by the laser excitation system 160 to spontaneously emit radiation. In a particular example, the laser active gas 106 can be a combination of carbon dioxide, helium, and nitrogen that emits light having a wavelength of about 9-11 μm. In a further example, the laser active medium 106 can be a solid. For example, the laser active medium 106 can include a dopant within a solid carrier or a solid particulate embedded within the core 102 of the optical fiber 150. As another example, the laser active medium 106 can include a solid particulate such as nanoparticles or be in a nanopowder form.

As shown in FIG. 1, for example, the laser excitation system 160 includes an oscillator 108 that can produce an oscillating electromagnetic field that is amplified by an amplifier 110 and inductively coupled to the laser active medium 106 through one or more coils 112. The oscillator 108 can produce an oscillating electric current signal having a frequency between about 100 kHz and about 100 GHz, and the amplifier 110 can amplify the signal to produce an oscillating current in the coil 112 with a power of several to several thousand Watts. The oscillating electrical current in the coil 112 produces an oscillating electromagnetic field in the laser active medium 106 within the hollow core 102 of the fiber 150. The laser excitation system 160 can include a matching network 113 inserted between the amplifier 110 and the coil 112 to match the impedance of the coil 112 to the impedance of the driving circuit that includes the oscillator 108 and the amplifier 110.

The energy coupled through the coil 112 from the amplifier 110 to the laser active medium 106 excites the laser active medium, such that stimulated emission of radiation and laser activity can occur within the medium 106. For example, the oscillating electromagnetic field produced by the coil 112 within a gaseous laser active medium 106 can partially ionize gases within the medium to create a plasma. When electrons from the plasma collide with gas molecules, the gas molecules can be excited to higher vibrational states. When the gas molecules decay to lower energy states they emit light having a wavelength characteristic of the molecule. When the emitted light is absorbed and reemitted by another excited molecule the other molecule is stimulated to emit additional radiation with the same wavelength and phase as the stimulating radiation. Electrons in the plasma can be guided along the length of the optical fiber 100 by a static or varying magnetic field that is aligned along the axis of the optical fiber 100. For example, a DC current produced by a current source 120 and flowing though a coil 122 wrapped around the optical fiber can creates a magnetic field along the axis of the coil, according to Lenz's law, for guiding the electrons. A magnetic field can also be created along the axis of the optical fiber 150 by a permanent magnet.

The hollow core fiber laser 100 also includes a rear reflector 114 and a front reflector 116 that are arranged at the ends of the hollow core optical fiber 150, such that radiation emitted within the laser active medium 106 oscillates between the rear reflector 114 and the front reflector 116 to create additional stimulated emission of radiation. When the gain of the radiation traveling through the laser active medium 106 is greater than the loss of the radiation traveling though the medium 106, the total radiation density within the cavity formed between the rear reflector 114 and the front reflector 116 is amplified as the radiation oscillates between the rear reflector 114 and the front reflector 116. The front reflector 116 can be partially reflecting and partially transmitting, such that a portion of the radiation oscillating within the cavity is emitted from the cavity in an output radiation beam 118.

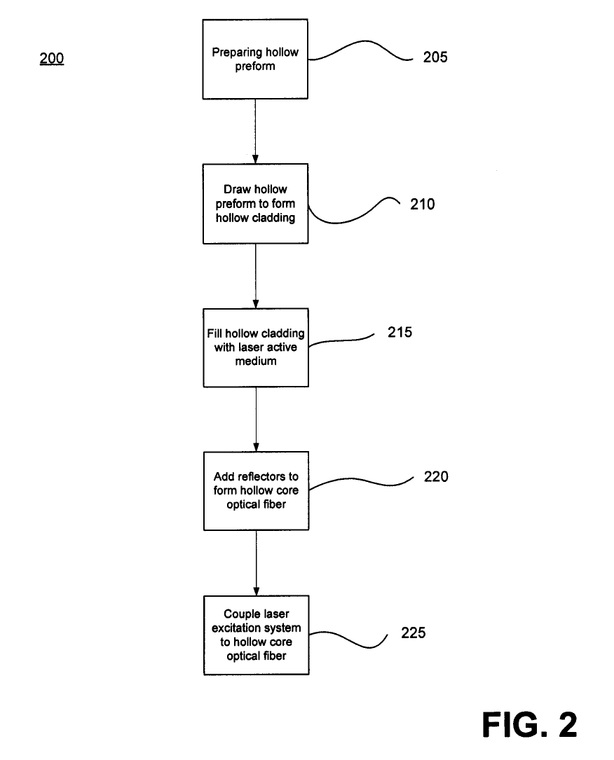

Referring to FIG. 2, the hollow core fiber laser 100 is formed using a procedure 200. Initially, a hollow preform is prepared (step 205). The hollow preform is prepared by preparing a film of cladding material and rolling the cladding material into a hollow body. The cladding material can be rolled by wrapping the cladding material around a tubular mandrel that can be etched out of the center of the rolled cladding material when rolling is complete to form the hollow body. The hollow body is then processed further to form the hollow preform. Processing of the hollow body can include heating or sintering the hollow body, cladding the hollow body with other layers, and cooling the hollow body. The cladding material can be poly(ether sulphone) (PES) or any suitable material. In some implementations, the cladding material can be multilayered, as discussed further below. Once the hollow preform is prepared (step 205), the hollow preform is drawn into a fiber cladding that is longer and thinner than the hollow preform (step 210). While the hollow preform is drawn, an outside diameter of the fiber cladding can be monitored with a laser to control the final outside diameter and to control the thickness of the cladding 104. Moreover, the initial thickness and length of the hollow preform can be adjusted to account for various lengths and thicknesses of the cladding 104.

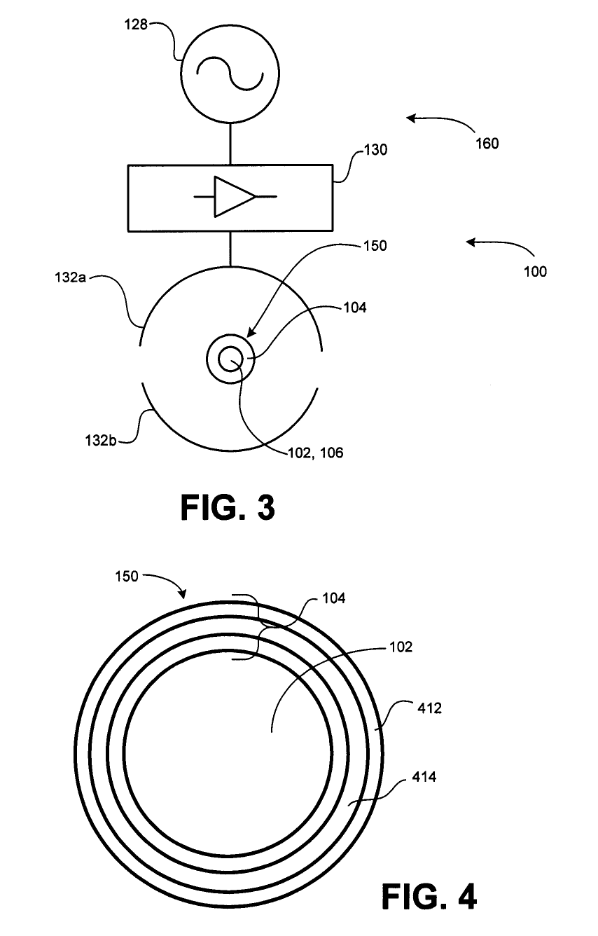

The hollow cladding 104, and in particular, the core 102 of the cladding 104 is then filled with laser active medium 106 (step 215). In one implementation, the hollow cladding 104 can be filled with laser active medium 106 by transmitting the laser active medium 106 through the core 102 of the cladding 104. For example, if the laser active medium 106 is a solid, then a particulate form such as a powdered or a crystal form of the solid material is delivered into the core 102. Then, the reflectors 114, 116 are secured to the cladding 104 with an air- or fluid-tight sealant such as, for example, epoxy, o-rings, a gasket to seal the laser active medium 106 within the cladding 104 by to form the hollow core optical fiber 150 (step 220). Lastly, the laser excitation system 160 is coupled to the hollow core optical fiber 150 (step 225).As shown in FIG. 3, in another implementation, the laser excitation system 160 couples energy into the laser active medium 106, and includes an oscillator 128 that can produce an oscillating electromagnetic field that is amplified by an amplifier 130 and coupled capacitively to the laser active medium 106 through conductive plates 132a, 132b. The conductive plates 132a, 132b can be shaped as partial cylinders (for example, half cylinders), so that points on the inner surface of the plate are equidistant from a center of the hollow core optical fiber 150. An oscillating voltage can be applied to one plate 132a, while a second plate 132b can be held at ground potential. The oscillating potential difference between the charged plate 132a and the grounded plate 132b creates an oscillating electromagnetic field in the laser active medium 106 within the hollow core 102 of the fiber 150, thereby exciting the laser active medium 106 such that stimulated emission of radiation and laser activity can occur within the medium 106.

While electromagnetic radiation is coupled into a gaseous laser active medium 106 within the optical fiber, ignition of a plasma within the gas can be caused by a brief burst of stimulating energy to the gas. For example, ultraviolet light, alpha radiation, or an electrical spark can be applied to the gas to ignite the plasma to ignite the plasma.

Referring to FIG. 4, in one implementation of the hollow core optical fiber 150, the cladding 104 includes a multilayer structure of alternating materials having a relatively high index of refraction and a relatively low index of refraction. Thus, one layer 412 has a relatively high index of refraction, and another layer 414 has a relatively low index of refraction, or vice versa. For example, the material in the layer 412 can be arsenic triselenide (Ar₂Se₃), which has an index of refraction of about 2.8, and the material in layer 414 can be PES, which has an index of refraction of about 1.55. As explained in Temelkuran et al., “Wavelength-scalable hollow optical fibers with large photonic bandgaps for CO2 laser transmission,” Nature, Vol. 420, 12 Dec. 2002, pp. 650-653, which is incorporated herein by reference in its entirety, the alternating layers of high- and low-index of refraction materials are arranged to create a photonic band gap structure that reflects light traveling within the hollow core 102 of the optical fiber 150. For example, a cladding 104 having 270 nm thick Ar₂Se₃ layers 412 alternating with 900 nm thick PES layers 414 transmits 3.55 μm wavelength light with ultralow radiation and absorption losses (for example, less than 0.1 dB/m).

A hollow core optical fiber having the cross section shown in FIG. 4 can be formed by thermally evaporating a 5-10 μm thick Ar₂Se₃ layer 412 onto a 25-50 μm thick PES film 414 and then rolling up the coated film to create a hollow multilayer preform tube having 4-100 alternating layers. The coated film also can be rolled onto a glass mandrel that is then etched out of the center of the preform tube. The layers of the hollow preform are sintered and consolidated by heating the hollow preform in a vacuum, and the preform can be clad with a protective outer layer of PES. The preform is then drawn into an optical fiber that is longer and thinner than the original preform. While the preform is drawn into a fiber, the outside diameter of the resulting fiber is monitored with a laser to control the final outside diameter of the preform and, consequently, the thickness of the alternating cladding layers to within about ±1% of the desired diameters and thicknesses. The initial layers of the preform can also be thicker than described above, such that longer lengths of final hollow core optical fibers are formed when the preform is drawn into a fiber.

As explained above, a hollow core optical fiber having 270 nm thick Ar₂Se₃ layers 412 alternating with 900 nm thick PES layers 414 transmits 3.55 μm wavelength light with very little loss. When the preform is drawn down to a smaller diameter, resulting in 240 nm thick Ar₂Se₃ layers alternating with 807 nm thick PES layers, the fiber transmits 3.1 μm wavelength light with very little loss.

Additionally, hollow core optical fibers having thicker cladding layers can be fabricated to transmit light output from a CO₂ laser. For example, a fiber having a 500-750 μm core diameter and a 1300-1500 μm outer diameter has very low transmission losses (for example, less than about 0.1 dB/m) for wavelengths of about 10-11 μm.

Hollow core optical fibers also can be created with different design parameters. For example, as explained in Ibanescu, et al., “Analysis of mode structure in hollow dielectric waveguide fibers,” Phys. Rev. E, vol. 67, 046608 (2003), which is incorporated herein by reference in its entirety, a fiber can be fabricated with alternating layers of n=4.6 and n=1.6 material having thicknesses of 0.33 a and 0.67 a, where a is total thickness of two adjacent layers. The inside diameter of the fiber core can vary from about 2 a to about 20 a. Such fibers for transmitting approximately 10.6 μm wavelength light have been made by and are commercially available from OmniGuide Communications, Inc. of Boston, Mass. Hollow core optical fibers can be fabricated to minimize transmission and radiation losses at wavelengths other than the transmission wavelength (10.6 μm) by selecting appropriate values of the indices of refraction and thicknesses of the alternating layers in the cladding.

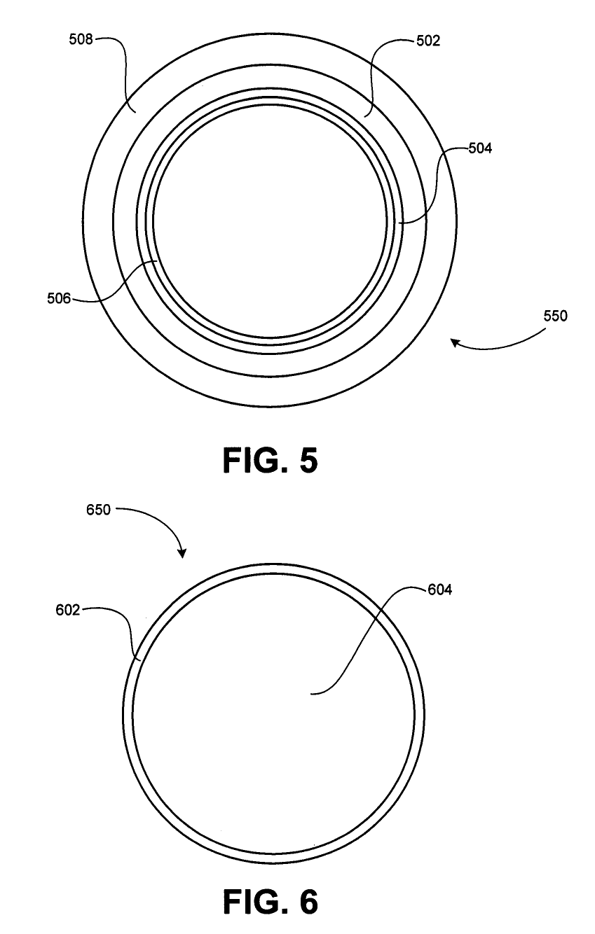

Referring to FIG. 5, in another implementation, a hollow core optical fiber 550 includes a hollow silica tube 502 that is coated along an inner surface with a layer 504 and a thin silver iodide layer 506. The thickness of the layers 504 and 506 is selected to provide high reflectivity at a particular wavelength or range of wavelengths. Such a fiber is described in Abel, et al., “Hollow glass waveguides for broadband infrared transmission,” Opt. Lett., vol. 19, pp. 1034-1036 (1994), which is incorporated herein by reference in its entirety. The silica tube 502 can be coated on its outer surface with a polymer coating of UV acrylate or polyimide 508 to provide mechanical strength to the fiber 550. The layer 504 can be made of silver, or any other suitable metal, such as, for example, gold, copper, or nickel.

As shown in FIG. 6, in another implementation, a hollow core optical fiber 650 can be fabricated from a uniform material cladding 602 that has an index of refraction lower than an index of refraction of a core 604. For particular wavelengths certain materials can have an index of refraction less than one, that is, less than the index of refraction of air or vacuum. For example, as described in J. A. Harrington and C. C. Gregory, “Hollow sapphire fibers for the delivery of CO₂ laser energy,” Opt. Lett., vol. 15, pp. 541-543 (1990), which is incorporated herein by reference in its entirety, when the cladding 602 is made of single crystal sapphire, which has an index of refraction of about 0.67 for 10.6 μm wavelength light, light is confined to travel in the hollow core 604 of the fiber 650.

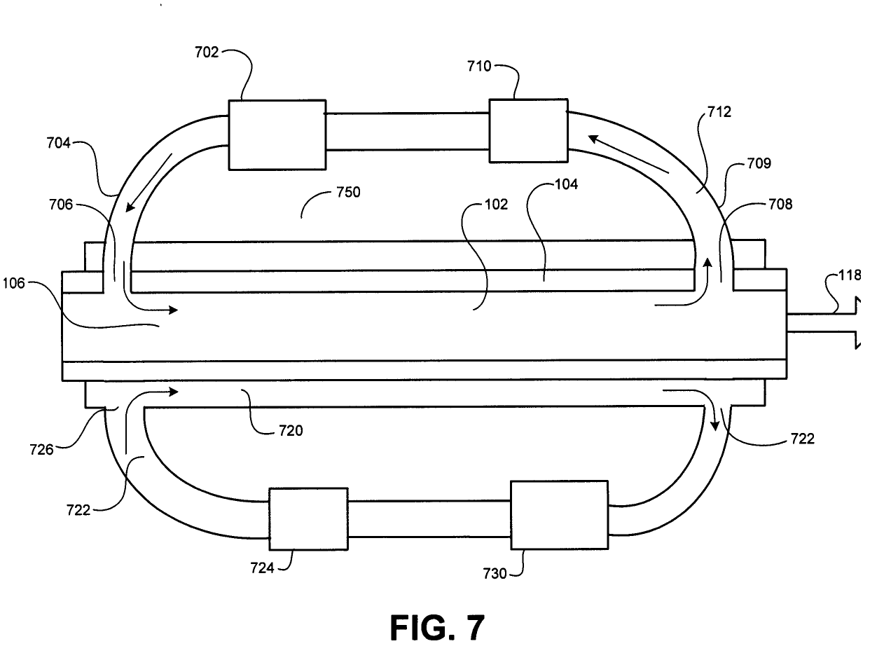

Referring to FIG. 7, in another implementation of a hollow core fiber laser including a hollow core optical fiber 750, the laser active medium 106 can be circulated through the core 102 of the fiber 750 during operation of the laser, and as laser light 118 is emitted from the fiber laser. The laser active medium 106 can be forced by a pump 702 to flow through a first tube 704, through an input hole 706 in the cladding 104 of the fiber 750, along the length of the core 102, where the active medium 106 is used to generated laser light. The flowing active medium 106 can exit the core 102 of the fiber 750 through an output hole 708 into a second tube 709 in which it can be routed to a regenerator 710 by way of a second tube 712. The input hole 706 and the output hole 708 can be bored though a wall of the fiber 750, for example, with a drill with a high power laser. The first tube 704 and the second tube 709 can be attached to the fiber 750 with an air tight sealant (for example, an epoxy, o-rings, or another air-tight seal).

The regenerator 710 can include a catalytic material to regenerate the active medium 106. For example, if the active medium is a CO₂ laser gas mixture, the regenerator 710 can catalyze the conversion of CO in the gas that exits the fiber 750 to CO₂. The laser active medium 106 output from the regenerator 710 can be fed to the pump 702.

Still referring to FIG. 7, a cooling fluid jacket 720 can surround the cladding 104 of the fiber 750, and cooling fluid (for example, water) 722 can be pumped through the cooling jacket 720 by a pump 724 to so that that cooling fluid can extract heat from the fiber 750 that is generated when the hollow core fiber 750 is operated as a laser such as in FIG. 1. The cooling fluid 722 can be pumped into the cooling jacket 720 through an intake hole 726 in an outside wall of the jacket and can flow out of the cooling jacket through an output hole 728 in the jacket. The fluid 722 that flows out of the cooling jacket can pass through a heat exchanger 730 that removes heat from the fluid before it passes to the pump 724 and is pumped back through the cooling jacket 720. Because the energy can be inductively coupled into the active medium 106 within the core 102 of the optical fiber 750, energy can be coupled into the active medium 106 through the cooling fluid 722 with very little loss. It can be difficult to couple energy through the cooling fluid when the frequency of the oscillating field carrying the energy matches a resonant frequency of the molecules in the cooling fluid (for example, 2.45 GHz for water). Thus, unlike optically-pumped fiber lasers, when energy is inductively pumped into the active medium 106, opaque claddings and jackets can be used on the fiber 750 and the pumping energy can be passed through the cooling jacket with very little loss. The cooling jacket 720 can be made of glass, but can also be made of a flexible and/or opaque material, such as a rubber hose or Tygon® tubing.

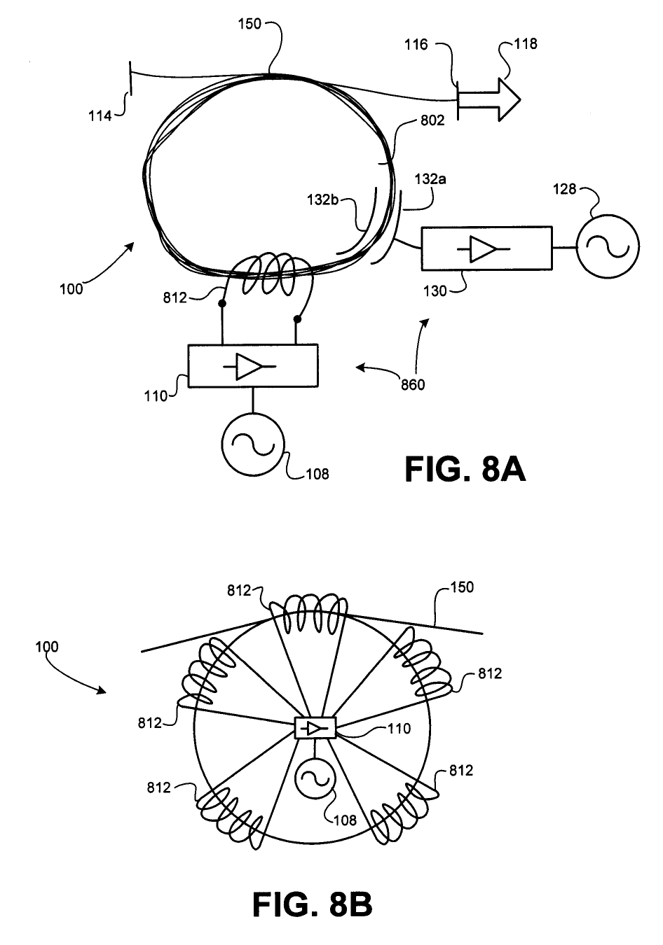

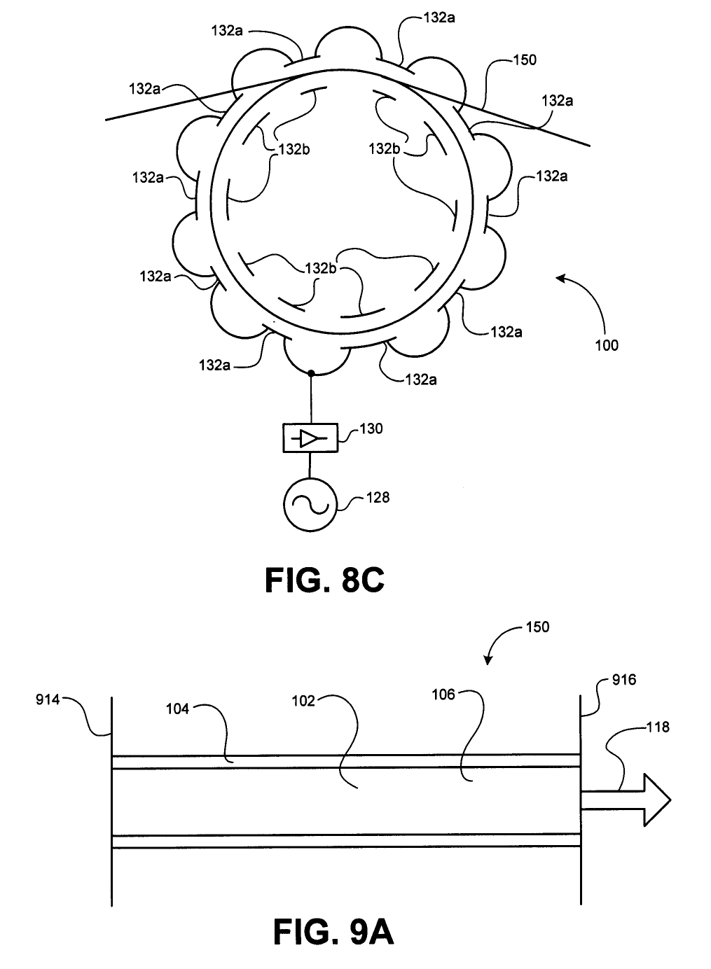

Referring to FIG. 8A, in another implementation, the hollow core optical fiber 150 is not linear, but is bent and/or arranged in a coil 802 that is coupled to a laser excitation system 860. The laser excitation system 860 can include an inductive coil 812 that encloses or is wrapped around multiple loops of the fiber coil 802 such that the inductive coil 812 can supply pumping energy simultaneously to the multiple loops of the fiber 150. Although a bend in the fiber 150 can increase the transmission loss, for high gain devices (for example, CO₂ lasers) the gain of the device can remain higher than the loss during a round trip from one end mirror 114 to another end mirror 116 even when the optical fiber is bent or coiled, so that laser action is possible in the coiled fiber geometry. The coiled fiber allows a compact arrangement of the hollow core optical fiber that does not require complicated optical elements to guide the light in a non-straight path.

As shown in FIG. 8A, the laser excitation system 860 couples energy into the active medium 106 within the core 102 of the hollow core optical fiber 150 either inductively or capacitively, or both inductively and capacitively. For example, the laser excitation system 860 can include the oscillator 108 that produces alternating current that can be amplified by the amplifier 110 and fed to the coil 812, which inductively couples electromagnetic energy into the active medium 106. As another example, the laser excitation system 860 can include the oscillator 128 that produces alternating voltage that can be amplified by the amplifier 130 and fed to the plate 132a that opposes the grounded plate 132b, where the fiber coil 802 extends between the plates 132a and 132b, which capacitively couple electromagnetic energy into the active medium 106.

As shown in FIG. 8B, in another implementation, the laser excitation system 860 can include two or more inductive coils 812 that can be driven by the oscillator 108 and the amplifier 110 or by multiple oscillators and amplifiers. The inductive coils 812 can be arranged around one or more loops of the hollow core optical fiber 150 to inductively couple energy into the active medium 106 within the fiber 150 to excite the active medium so that laser action within the fiber 150 can occur. The inductive coils 812 can be driven independently or can be connected in parallel or in series with each other.

As shown in FIG. 8C, in another implementation, the laser excitation system 860 can include two or more pairs of capacitive plates 132a and 132b that can be driven by the oscillator 128 and the amplifier 130 or by multiple oscillators and amplifiers. The pairs of plates 132a and 132b can be arranged around one or more loops of the hollow core optical fiber 150 to capacitively couple energy into the active medium 106 within the fiber 150 to excite the active medium so that laser action within the fiber 150 can occur. The plates 132a, 132b can be driven independently or can be connected in parallel or in series with each other.

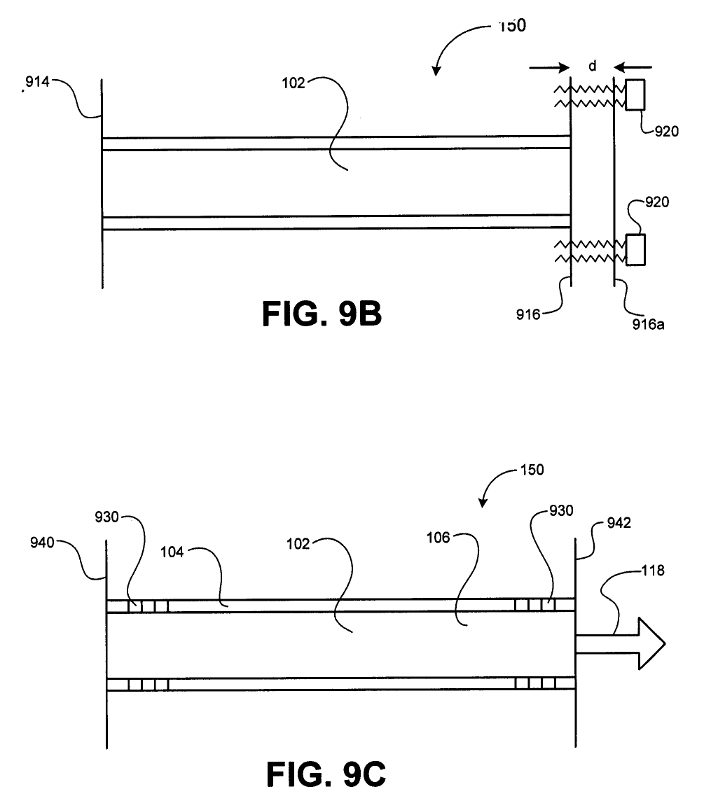

Referring to FIGS. 9A, 9B, and 9C, several alternative reflector arrangements for the hollow core fiber laser 100 are shown. As shown in FIG. 9A, the laser 100 can include reflectors 914 and 916 that can be optical elements that are totally or partially reflective. For example, a totally or nearly reflective optical element 914 can be a first surface reflective mirror having a reflective metal surface, and the partially reflective optical element 916 can be a glass or crystal that partially reflects light back into the hollow core 102 of the fiber 150 and partially transmits radiation 118 out of the fiber 150. Appropriate materials can be chosen for the partially reflective optical element 916 depending on the wavelength of the output light, the power within the laser cavity, and the geometry of the laser cavity. For example, a ZnSe crystal can be used when the active medium 106 is carbon dioxide and about 1-5000 Watts of approximately 10.6 μm wavelength light 118 is output from the fiber 150.

Alternatively, as shown in FIG. 9B, the partially reflective optical element 916 can be placed a distance, d, away from the end of the hollow core optical fiber 150, which then can be sealed with a transparent optical element 916a. The distance, d, between the partially reflective optical element 916 and the transparent element 916a can be adjusted (for example, by one or more tuning screws 920) to adjust the amount of feed back from the element 916 into the hollow core 102 of the fiber 150.

Alternatively, as shown in FIG. 9C, the hollow core fiber laser 100 can include Bragg gratings 930 written into the cladding 104 of the optical fiber 150 to selectively reflect particular wavelengths of light. The Bragg gratings 930 can be written into the cladding 104 by exposing a photosensitive material in the cladding 104 to a period pattern of UV light to alter the index of refraction of the material in a pattern corresponding the pattern of the light. The reflectivity of the Bragg grating 930 is controlled by controlling the length and the refractive index contrast in the Bragg grating 930. Because the Bragg gratings 930 are written into the cladding 104 of the optical fiber 150, the active material 106 can be sealed within the core 102 of the optical fiber 150 by a reflective optical element 940 and a transparent optical element 942.

Other Implementations

A number of implementations have been described. Nevertheless, it will be understood that various modifications can be made. Accordingly, other implementations are within the scope of the following claims.

For example, the optical fiber 150 can be a hollow core optical fiber obtained from CorActive High-Tech Inc. of Quebec Canada. As another example, the optical fiber 150 can be a hollow photonic bandgap fiber, which does not guide light by total internal reflection but relies on a photonic bandgap in the cladding of the fiber. Such hollow photonic bandgap fibers can be obtained from Coming of Corning, N.Y. or from Crystal Fiber of Blokken 84, 3460 Birkerod, Denmark.

In another implementation, the hollow core fiber laser 100 can be mounted within a solid block that can act as a mount and a device for sealing ends of the hollow core 102. In this way, the reflectors 114, 116 can be mounted in the block. Moreover, the block can be formed with openings that provide inlets or outlets for the laser active medium. In one implementation, the solid block is made of aluminum.

Thus, for example, the input hole 706 and the output hole 708 can be bored though the block, for example, with a drill with a high power laser. In this case, the first tube 704 and the second tube 709 are formed within the block and the holes 706, 708 access the core 102 at a location between the end of the cladding 104 and the reflectors. The entire assembly can therefore be sealed with the block instead of sealing the reflectors directly to the cladding 104.

In another implementation, a small hole can be bored through the cladding 104 to allow the introduction of the laser active medium 106 into the hollow core 102 of the cladding 104 (step 215). Then, after filling the hollow core 102, the hole in the cladding 104 can be sealed with an air- or fluid-tight sealant.

What is claimed is:

1. A laser comprising:
an optical fiber comprising a cladding defining a hollow core;
a laser active medium within the core of the optical fiber;
a first reflector and a second reflector defining a cavity within at least a portion of the optical fiber; and
an excitation system coupled to the laser active medium to stimulate laser action within the core of the optical fiber;
wherein the laser active medium includes a gas, a liquid, or a particulate solid.

2. The laser of claim 1, wherein the excitation system comprises:
an electrical power source, and
at least one electrode adapted for coupling electrical energy from the electrical power source through the cladding into the laser active medium.

3. The laser of claim 2, wherein the at least one electrode comprises a coil wrapped around the optical fiber, the coil being adapted for inductively coupling electromagnetic energy into the laser active medium.

4. The laser of claim 2, wherein the at least one electrode comprises a pair of plates around the optical fiber, the plates being adapted for capacitively coupling electromagnetic energy into the laser active medium.

5. The laser of claim 2, wherein the electrical power source includes an oscillator adapted for producing an oscillating electromagnetic signal.

6. The laser of claim 5, wherein the electromagnetic signal produced by the oscillator has a frequency between about 1 kHz and about 100 GHz.

7. The laser of claim 1, wherein at least one of the reflectors is a mirror.

8. The laser of claim 1, wherein at least one of the reflectors is a distributed Bragg reflector.

9. The laser of claim 1, wherein the laser active medium comprises carbon dioxide.

10. The laser of claim 1, wherein the laser active medium comprises a laser active dye.

11. The laser of claim 1, further comprising:
a cooling jacket surrounding at least a portion of the optical fiber; and
a cooling fluid flowing through the cooling jacket.

12. The laser of claim 1, further comprising a means for creating a magnetic field in a direction approximately parallel to at least a portion of the optical fiber.

13. The laser of claim 1, further comprising a permanent magnet arranged to create a magnetic field in a direction approximately parallel to at least a portion of the optical fiber.

14. The laser of claim 1, further comprising an electromagnet arranged to create a magnetic field in a direction approximately parallel to at least a portion of the optical fiber.

15. The laser of claim 1, wherein the optical fiber is arranged in a loop.

16. The laser of claim 1, wherein the core has a diameter that is less than about 100 times greater than a wavelength of light emitted from the laser.

17. The laser of claim 1, wherein the cladding comprises alternating layers, in a radial direction, of high and low index of refraction material.

18. The laser of claim 18, wherein the cladding comprises at least 10 alternating layers of high and low index of refraction material.

19. The laser of claim 1, wherein the optical fiber is a photonic bandgap fiber.

20. The laser of claim 1, wherein the cladding comprises a metallic layer.

21. A method of generating laser radiation, the method comprising:
providing an optical fiber having a laser active medium of gas, liquid, or particulate solid within a core of the fiber;
providing a first reflector and a second reflector between which at least a first portion of the optical fiber is located, the first and second reflectors and the first portion of the optical fiber defining a laser cavity; and
coupling sufficient energy through the optical fiber to generate laser radiation within the laser cavity.

22. The method of claim 21, wherein coupling sufficient energy includes coupling sufficient electromagnetic energy through a cladding of the optical fiber.

23. The method of claim 21, further comprising flowing the laser active medium through the core of the optical fiber.

24. The method of claim 21, further comprising:
flowing a cooling fluid around at least a second portion of the optical fiber; and
coupling the energy through the cooling fluid to the laser active medium.

25. The method of claim 21, further comprising creating a magnetic field in a direction approximately parallel to at least a portion of the optical fiber.

26. The method of claim 21, wherein coupling sufficient energy includes inductively coupling electromagnetic energy into the laser active medium of the optical fiber.

27. The method of claim 21, wherein coupling sufficient energy includes capacitively coupling electromagnetic energy into the laser active medium of the optical fiber.

28. A method of making a laser, the method comprising:
preparing a hollow preform;
drawing the hollow preform into a hollow fiber cladding that defines a core;
filling the core with a laser active medium;
coupling reflectors to the hollow fiber cladding to form a hollow core optical fiber; and
coupling an excitation system to the laser active medium to enable laser action within i5 the hollow core optical fiber.

29. The method of claim 28, wherein filling the core with the laser active medium includes filling the core with a gaseous laser active medium.

30. The method of claim 28, wherein filling the core with the laser active medium includes filling the core with a liquid laser active medium.

31. The method of claim 28, wherein filling the core with the laser active medium includes filling the core with a solid laser active medium.

32. The method of claim 31, wherein the solid laser active medium includes a solid particulate.
